(19) United States
(12) Patent Application Publication
(10) Pub. No.: US 2026/0140771 A1
(43) Pub. Date: May 21, 2026

(54) SYSTEM AND METHOD FOR DIRECTING RESOURCE ALLOCATIONS USING AN ARTIFICIAL INTELLIGENCE AGENT

(71) Applicant: BANK OF AMERICA CORPORATION, CHARLOTTE, NC (US)

(72) Inventors: Katherine Dintenfass, McLean, VA (US); Charles Phillip Valentine, Charlotte, NC (US); Eytan Alon, Charlotte, NC (US); Nicole Jenean Day, Acworth, GA (US)

(73) Assignee: BANK OF AMERICA CORPORATION, CHARLOTTE, NC (US)

(21) Appl. No.: 18/950,781

(22) Filed: Nov. 18, 2024

(51) Int. Cl. G06F 9/50

(52) U.S. Cl. CPC G06F 9/5027

(57) ABSTRACT

A system is provided for an integrated infrastructure data monitoring framework. In particular, the system may generate a virtualized community of users based on anonymized and/or virtualized versions of users based on historical user data. Each of the virtualized users may be an artificial intelligence-based agent that may interact with a target user to provide feedback to the user regarding the user's preferences and/or goals. The AI agents may further be interactable with respect to the target user such that the target user may pose queries to the AI agent. In this regard, the system may establish a personalized group of AI agents tailored to the needs of the user. In this way, the system may provide an efficient way to direct the allocation of resources using the AI agents.

### TECHNOLOGICAL FIELD

Example embodiments of the present disclosure relate to a system for directing resource allocations using artificial intelligence based agents.

### BACKGROUND

There is a need for an intelligent and efficient way to allocate resources.

### BRIEF SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

A system is provided for an integrated infrastructure data monitoring framework. In particular, the system may generate a virtualized community of users based on anonymized and/or virtualized versions of users based on historical user data. Each of the virtualized users may be an artificial intelligence-based agent that may interact with a target user to provide feedback to the user regarding the user's preferences and/or goals. The AI agents may further be interactable with respect to the target user such that the target user may pose queries to the AI agent. In this regard, the system may establish a personalized group of AI agents tailored to the needs of the user. In this way, the system may provide an efficient way to direct the allocation of resources using the AI agents.

Accordingly, embodiments of the present disclosure provide a system for directing resource allocations using artificial intelligence based agents, the system comprising: a processing device; a non-transitory storage device containing instructions when executed by the processing device, cause the processing device to perform the steps of: receiving, over a network, a query from a user device associated with a user; analyze a user record associated with the user, wherein the user record comprises historical data associated with the user and user-defined settings; based on the query and analyzing the user record, generating one or more artificial intelligence agents based on the historical data and the user-defined settings; and transmitting, through the one or more artificial intelligence agents, one or more communications to the user device, wherein the one or more communications comprises a recommended resource allocation.

In some embodiments, each of the one or more artificial intelligence agents comprise one or more unique characteristics, the one or more unique characteristics comprise at least one of a name, appearance, voice, and communication style.

In some embodiments, each of the one or more artificial intelligence agents is associated with a unique role based on the user record.

In some embodiments, analyzing the user record comprises identifying one or more targets associated with the user, wherein the recommended resource allocation is based on the one or more targets associated with the user.

In some embodiments, the user record comprises zero-party data and first-party data associated with the user.

In some embodiments, the first-party data comprises inferred information based on past user interactions.

Embodiments of the present disclosure also provide a computer program product for directing resource allocations using artificial intelligence based agents, the computer program product comprising a non-transitory computer-readable medium comprising code causing an apparatus to perform the steps of: receiving, over a network, a query from a user device associated with a user; analyze a user record associated with the user, wherein the user record comprises historical data associated with the user and user-defined settings; based on the query and analyzing the user record, generating one or more artificial intelligence agents based on the historical data and the user-defined settings; and transmitting, through the one or more artificial intelligence agents, one or more communications to the user device, wherein the one or more communications comprises a recommended resource allocation.

In some embodiments, each of the one or more artificial intelligence agents comprise one or more unique characteristics, the one or more unique characteristics comprise at least one of a name, appearance, voice, and communication style.

In some embodiments, each of the one or more artificial intelligence agents is associated with a unique role based on the user record.

In some embodiments, analyzing the user record comprises identifying one or more targets associated with the user, wherein the recommended resource allocation is based on the one or more targets associated with the user.

In some embodiments, the user record comprises zero-party data and first-party data associated with the user.

In some embodiments, the first-party data comprises inferred information based on past user interactions.

Embodiments of the present disclosure also provide a computer-implemented method for directing resource allocations using artificial intelligence based agents, the computer-implemented method comprising: receiving, over a network, a query from a user device associated with a user; analyze a user record associated with the user, wherein the user record comprises historical data associated with the user and user-defined settings; based on the query and analyzing the user record, generating one or more artificial intelligence agents based on the historical data and the user-defined settings; and transmitting, through the one or more artificial intelligence agents, one or more communications to the user device, wherein the one or more communications comprises a recommended resource allocation.

In some embodiments, each of the one or more artificial intelligence agents comprise one or more unique characteristics, the one or more unique characteristics comprise at least one of a name, appearance, voice, and communication style.

In some embodiments, each of the one or more artificial intelligence agents is associated with a unique role based on the user record.

In some embodiments, analyzing the user record comprises identifying one or more targets associated with the user, wherein the recommended resource allocation is based on the one or more targets associated with the user.

In some embodiments, the user record comprises zero-party data and first-party data associated with the user.

In some embodiments, the first-party data comprises inferred information based on past user interactions.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing system for directing resource allocations using artificial intelligence based agents, in accordance with an embodiment of the disclosure;

FIG. 2 illustrates an exemplary generative AI subsystem architecture, in accordance with an embodiment of the disclosure; and

FIG. 3 illustrates a method for directing resource allocations using artificial intelligence based agents, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, unique characteristic information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, “resource” may refer to a tangible or intangible object that may be used, consumed, maintained, acquired, exchanged, and/or the like by a system, entity, or user to accomplish certain objectives. Accordingly, in some embodiments, the resources may include computing resources such as processing power, memory space, network bandwidth, bus speeds, storage space, electricity, and/or the like. In other embodiments, the resources may include objects such as electronic data files or values, authentication keys (e.g., cryptographic keys), document files, funds, digital currencies, and/or the like.

In the information age, users may receive various types of data regarding resource allocations. That said, it may be difficult for users to determine whether and/or which types of data are applicable to the user's preferences, goals, targets, and/or the like with respect to the resources owned or associated with the user. Accordingly, there is a need for an intelligent and efficient way to provide the user with customized and/or personalized data regarding resource allocations.

To address the above concerns among others, a system is provided for directing resource allocations using artificial intelligence based agents. In various embodiments, the system may be configured to generate a virtualized community of users by creating anonymized or virtualized versions of users derived from historical user data. Each virtualized user may be represented by an artificial intelligence (“AI”) agent that may interact with a designated target user to provide personalized inputs based on the user's preferences, goals, or other areas of interest. In this regard, the AI agent may analyze a user record that may comprise zero-party and/or first-party data associated with the user, which may include various types of data, such as user settings or preferences, historical user behavior or transaction data, application usage, and/or the like. Based on analyzing the user record, the AI agent may produce a generative output that may be tailored in accordance with the user record. To this end, the AI agents may be designed to engage in interactive communication with the target user, allowing the user to ask questions or seek advice on various topics (e.g., how to direct resource allocations).

In some embodiments, the system may establish a set of AI agents, where each of the AI agents may be uniquely tailored to at least one aspect of the user's preferences or settings. In this regard, certain AI agents within the virtualized community may be generated by the system to fulfill specific roles to support the user in different ways. For instance, a first AI agent may provide inputs regarding the user's goals, a second AI agent may provide a structured plan or layout for resource allocations, and AI third AI agent may provide analytical insights. In this way, the system may create a multi-faceted virtual environment that is adjustable to the target user's evolving requirements and preferences.

In some embodiments, the AI agents may also provide proactive reminders or recommendations based on ongoing analysis of the user's status, behavior, or detected status or state. In this regard, the system may analyze historical data (e.g., by analyzing the user record associated with the user) and/or current information regarding the user (e.g., data collected regarding the user through a user computing device such as a smartphone, wearable smart device, and/or the like). For instance, the system may detect one or more elevated biological metrics through a wearable device of the user, and thereby determine that the user is in an elevated emotional state. In such a scenario, the AI agents may modify their generated outputs based on the elevated state of the user. For instance, the communication style of the AI agents may be modified to be more empathetic or supportive. Additionally or alternatively, the AI agents may modify the recommendations regarding resource allocations according to the elevated state.

The following exemplary embodiment is provided for illustrative purposes and is not intended to restrict the scope of the disclosure provided elsewhere herein. In one embodiment, the system may provide a user input such as a query with respect to a resource allocation (e.g., a transaction, purchase, investment, and/or the like). For instance, the user may submit a query regarding the most optimal way to invest the resources held within a user account (e.g., a resource account hosted by a financial institution). Based on receiving the user query, the system may analyze the user record associated with the user, where the user record may contain information such as resource account information (e.g., resource amount, resource type, transaction history, and/or the like), user preferences or settings (e.g., the user favors certain investment vehicles over others), user targets or goals (e.g., the user specifies a target growth of 10%), and/or the like.

Based on analyzing the user record and the user query, the system may generate one or more AI agents to serve as points of contact and/or communication between the system and the user, where each of the one or more AI agents may be uniquely generated in accordance with the user record and user query. In this regard, each AI agent may have a unique name, visual appearance, voice, communication style or tone, and/or the like. In this way, the one or more AI agents may form a virtualized community of users with which the user may interact to pose questions, receive insights and reminders, and/or the like. Each of the AI agents may further be tailored to address a specific portion of the user's preferences and/or goals. For instance, a first AI agent may be an “notification agent” that may track a user's progress or status with respect to a particular goal and/or transmit reminders to the user when the system detects that the user is preparing to take an action that is contrary to the user's preferences or goals (e.g., the user is about to overspend in a particular spending category). Another AI agent (e.g., a second AI agent) may be an “analyst agent” that may provide financial analyses of the user's resources and potential outcomes that may be realized based on a particular allocation of the user's resources (e.g., the user chooses to allocate resources to vehicle A as opposed to vehicle B). Yet another AI agent (e.g., a third AI agent) may be a “progress agent” that may provide an overview of the user's progress toward the user's targets or goals and provide insights or recommendations to allow the user to stay on track toward the targets or goals.

The system as described herein provides numerous technical advantages over conventional resource allocation systems. For instance, by using one or more AI agents generated based on the user query and/or user record, the system may enhance the user experience of the user interacting with the system to manage the user's resource allocations. Furthermore, by analyzing all facets of the user's historical information and current status, the system may be able to provide tailored recommendations in accordance with the user's needs.

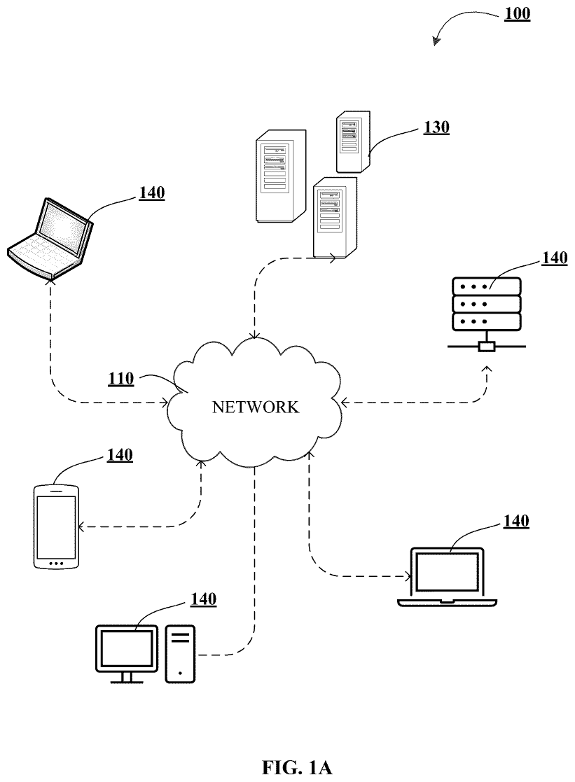

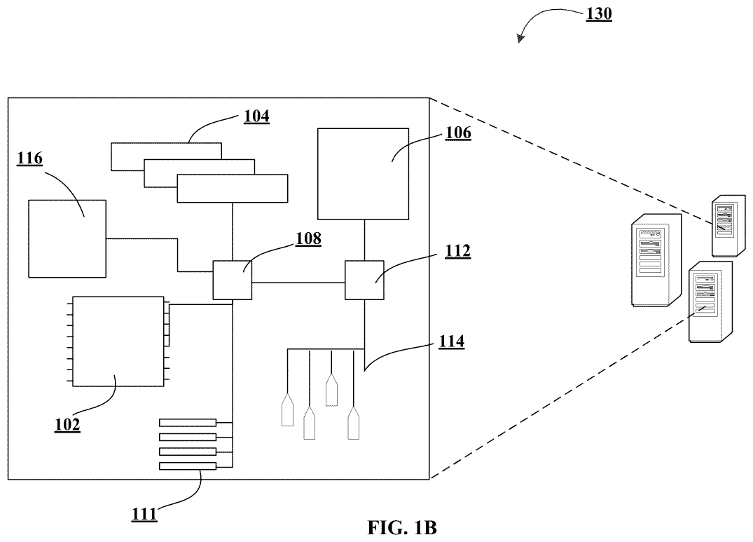

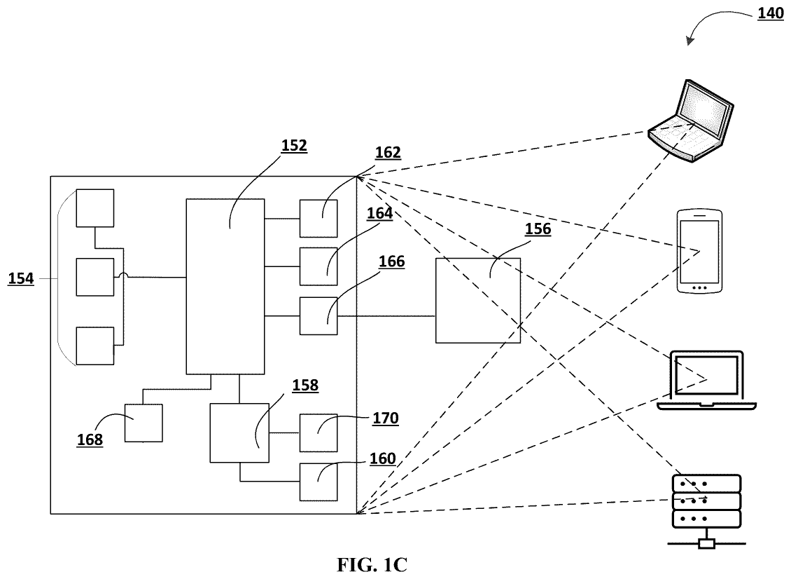

Turning now to the figures, FIGS. 1A-1C illustrate technical components of an exemplary distributed computing environment 100 for the system for directing resource allocations using artificial intelligence based agents. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. For instance, the functions of the system 130 and the endpoint devices 140 may be performed on the same device (e.g., the endpoint device 140). Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it. In some embodiments, the system 130 may provide an application programming interface (“API”) layer for communicating with the end-point device(s) 140.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as servers, networked storage drives, personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102 (which may also be referred to herein as a “processing device”), memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

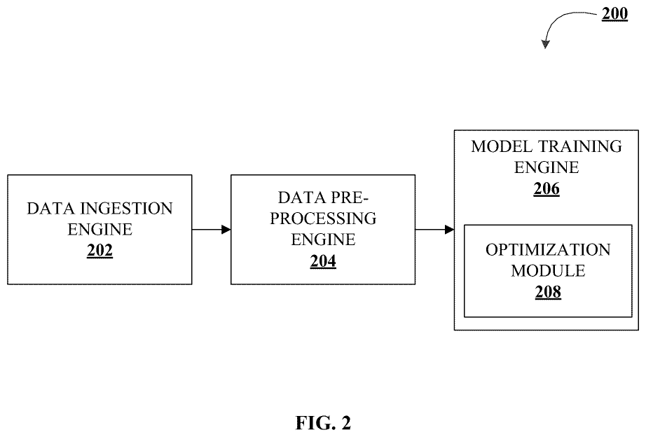

FIG. 2 illustrates an exemplary generative AI subsystem 200, in accordance with an embodiment of the invention. The generative AI subsystem 200 may include a data ingestion engine 202, a data pre-processing engine 204, and a model training engine 206. It should be understood that the generative AI subsystem 200 is merely an example, and other embodiments may include more, fewer, or different components depending on the specific requirements and implementations of the system. For instance, additional engines for data validation, feature selection, or distributed computing may be integrated into the subsystem, or certain components described herein may be consolidated or omitted based on system performance objectives. Therefore, the generative AI subsystem 200 should not be considered limiting and may be adapted to various configurations within the scope of the invention.

The data ingestion engine 202 may identify various internal and/or external data sources to generate, test, and/or integrate new features for training the generative AI model. These internal and/or external data sources (e.g., text corpora, web-based text data, document repositories, or decentralized text storage system) may be initial locations where the data originates or where physical information is first digitized. In addition to conventional data sources, the data ingestion engine 202 may support decentralized storage systems, such as blockchain-based data sources, and privacy-preserving methods such as differential privacy. The data ingestion engine 202 may identify the location of the data and describe connection characteristics for access and retrieval of data. In some embodiments, data is transported from each data source using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the data sources may include Enterprise Resource Planning (ERP) databases that host data related to day-to-day business activities such as accounting, procurement, project management, exposure management, supply chain operations, and/or the like, mainframes that are often the entity's central data processing center, edge devices that may be any piece of hardware, such as sensors, actuators, gadgets, appliances, or machines, that are programmed for certain applications and may transmit data over the internet or other networks, and/or the like.

Depending on the nature of the data, the data ingestion engine 202 may move the data to a destination for storage or further analysis. Typically, the data may be in varying formats as the data comes from different sources, including RDBMS, other types of databases, S3 buckets, CSVs, or from streams. For a large language model (“LLM”), text data may originate from sources such as web scrapes, social media, large public text datasets, or the like. Since the data may come from different places, the data needs to be cleansed and transformed so that the data may be analyzed together with data from other sources. The data may be ingested in real-time, using stream processing, in batches using a batch data warehouse, or in a combination of both. Stream processing may be used to process continuous data streams (e.g., data from edge devices) by computing on data directly as it is received, and filtering the incoming data to retain specific portions that are deemed useful by aggregating, analyzing, transforming, and/or ingesting the data. On the other hand, the batch data warehouse may collect and transfer data in batches according to scheduled intervals, triggered events, and/or any other logical ordering.

The generative AI subsystem 200 may utilize one or more machine learning techniques to generate new content. In machine learning, the quality of data and the useful information that may be derived therefrom directly affects the ability of the machine learning model to learn. The data pre-processing engine 204 may implement advanced integration and processing steps needed to prepare the data for machine learning execution, including tokenization, text normalization, and/or removal of irrelevant elements like HTML tags in web-based data, especially for LLM training. This may include modules to perform any upfront data transformation to consolidate the data into alternate forms by changing the value, structure, and/or format of the data by using generalization, normalization, attribute selection, aggregation, and text-specific transformations such as stemming and lemmatization to data clean by filling missing values, smoothing the noisy data, resolving the inconsistency, removing outliers, and/or any other encoding steps as needed. In some embodiments, the data pre-processing engine 204 may perform real-time pre-processing at the edge via edge computing devices, allowing for the transformation and reduction of data prior to transmission to centralized locations, thereby reducing latency and conserving network bandwidth.

In addition to improving the quality of the data, the data pre-processing engine 204 may transform categorical data into numerical formats that may be suitable for machine learning algorithms. In this regard, the data pre-processing engine 204 may use techniques such as one-hot encoding or label encoding depending on the nature of the categorical variables and the intended use of the data.

In some embodiments, the data pre-processing engine 204 may also include dimensionality reduction techniques, where the number of input features is reduced while retaining the most relevant information. In this regard, the data pre-processing engine 204 may include methods such as Principal Component Analysis (PCA) or apply feature selection algorithms to remove redundant or irrelevant features, thereby reducing the computational complexity of the model training phase. Feature selection may be particularly beneficial in datasets with a high number of features, ensuring that the generative AI models do not overfit to noise or irrelevant details. The pre-processed data output from the data pre-processing engine 204 may then be fed into the model training engine 206.

The model training engine 206 may be responsible for training the generative AI models using the pre-processed data from the data pre-processing engine 204. The model training engine 206 may implement various machine learning algorithms, including but not limited to Generative Adversarial Networks (GANs), Variational Autoencoders (VAEs), transformers, diffusion models, and/or other specialized architectures depending on the specific requirements of the system. These models may be used in a broad range of applications, such as LLMs for text generation, image generation models, video synthesis models, audio generation models, and/or the like. The model training engine 206 may optimize these models by continuously adjusting their internal parameters based on the patterns and relationships identified within the data.

In some embodiments, the model training engine 206 may include a training data handler, which manages the partitioning of the pre-processed data into training, validation, and testing datasets. The training data may be used to update the model's parameters, while the validation and testing datasets may be reserved to evaluate the model's performance during and after training. The model training engine 206 may support various data-handling strategies, such as cross-validation or random shuffling, to ensure that the model generalizes well and is not overfitting to the training data.

In embodiments involving large language models, the model training engine 206 may utilize transformer-based architectures, such as the Transformer, BERT, GPT, or the like. Transformer models rely on mechanisms like self-attention to capture dependencies between words in a sequence, regardless of their distance from one another. The self-attention mechanism allows the model to weigh the importance of different words in a sentence and establish complex relationships important for understanding context. During training, the model may process vast amounts of text data and learn to predict the next word or token in a sequence based on the input context. This training process allows LLMs to generate coherent text, complete sentences, translate languages, or answer questions based on learned patterns from the data.

The transformer-based LLMs may be trained using autoregressive (e.g., GPT) or masked-language modeling techniques (e.g., BERT). In autoregressive models, the training process may include predicting the next word in a sequence by progressively revealing more context to the model. The model iteratively improves its predictions based on its performance during prior iterations. Masked-language modeling involves masking certain words in a sentence and training the model to correctly predict the masked words based on surrounding context. Both approaches enable LLMs to capture intricate patterns in human language, improving their ability to handle tasks such as summarization, translation, and text generation. Loss functions like cross-entropy loss may be used to optimize the model's performance by comparing predicted tokens with the actual tokens in the dataset to guide the model to minimize prediction errors during training, as described in further detail herein.

In embodiments involving image generation models, the model training engine 206 may utilize transformer-based architectures, such as Vision Transformers (ViTs) or generative adversarial networks (GANs). Vision Transformers rely on self-attention mechanisms to process images as sequences of patches rather than whole images, allowing the model to capture spatial dependencies and patterns across the image. During training, the model may be exposed to large datasets containing diverse image types to learn features like textures, edges, and shapes. The model may then generate or reconstruct images by interpreting these patterns and applying learned spatial relationships. GAN-based models may also be used, where a generator network creates images, and a determinator network evaluates their realism, enabling the model to improve through adversarial training.

Image generation models may employ various training techniques, such as pixel-wise reconstruction or adversarial training, depending on the architecture. Pixel-wise reconstruction methods involve learning to reconstruct an image from its corrupted or downscaled version, optimizing the model to minimize the difference between the predicted and actual pixels (e.g., using mean squared error as the loss function). Adversarial training, often used with GANs, involves iteratively improving the generator network to produce images that are increasingly indistinguishable from real images, based on feedback from the determinator network. These approaches allow the model to capture complex visual features, enabling applications such as image synthesis, enhancement, and style transfer.

For video generation models, the model training engine 206 may employ transformer-based architectures like Video Transformers or GAN-based models specifically designed for handling temporal sequences. Video Transformers use self-attention mechanisms to model dependencies not only between pixels within a single frame but also across frames, allowing them to understand temporal relationships and motion patterns in videos. The model may be trained on large video datasets, enabling it to learn and reproduce dynamic changes and interactions between objects over time. GAN-based video models may incorporate spatiotemporal networks to evaluate the realism of generated video sequences, optimizing the model to produce continuous and coherent frames.

Video generation models may utilize spatial-temporal modeling techniques or adversarial training for generating realistic motion and video sequences. Spatial-temporal modeling involves learning the spatial features within each frame while simultaneously capturing the temporal dependencies between frames, optimizing the model's ability to predict future frames or complete missing sequences. Loss functions like mean squared error or perceptual loss may be applied to reduce discrepancies between predicted and actual frames. Adversarial training, on the other hand, may involve a generator creating video sequences and a determinator evaluating their realism, encouraging the generator to improve by minimizing the discrepancy identified by the determinator. These techniques may enable video generation models to create coherent and realistic sequences, useful in applications such as video synthesis and animation.

In audio generation models, the model training engine 206 may utilize architectures such as Audio Transformers or recurrent neural networks (RNNs) like WaveNet, designed to handle sequential and waveform data. Audio Transformers leverage attention mechanisms to capture relationships between segments of audio, allowing them to model temporal dependencies and predict the next audio sample based on previous context. During training, the model may process large audio datasets containing diverse sound patterns to learn representations of different audio features, such as frequency, amplitude, and harmonics. This training enables the model to generate coherent audio sequences, including speech, music, or ambient sounds, by synthesizing these learned patterns.

Audio generation models may be trained using sequence modeling techniques or autoregressive methods, depending on the architecture. Sequence modeling techniques involve processing and predicting sequences of audio samples, optimizing the model to capture and reproduce temporal dependencies in sound. Autoregressive methods, such as those employed in WaveNet, focus on predicting each audio sample based on prior samples, progressively refining the generated audio sequence over multiple iterations. Loss functions like mean absolute error or cross-entropy loss may be used to minimize the error between predicted and actual audio samples, guiding the model to improve its accuracy. These approaches allow audio generation models to create continuous and realistic audio outputs, applicable in areas such as speech synthesis, music generation, and sound effect creation.

The reconstruction loss ensures that the difference between the original input and the reconstructed output is minimized, guiding the decoder to generate outputs that closely resemble the input data. The second component, KL divergence loss, regularizes the latent space by ensuring that the distribution of latent variables conforms to a predefined probabilistic distribution, often a Gaussian distribution. This constraint encourages the model to learn a well-organized and smooth latent space, allowing for meaningful sampling from this space during inference. By combining these loss functions, the VAE can learn a latent space that not only captures the underlying patterns in the data but also allows for the generation of novel outputs by sampling new points from this space. During the inference phase, the trained model can sample random points from the latent space to generate new, previously unseen data instances.

In training generative AI models, the model training engine 206, which includes an optimization module 208, may implement various optimization techniques to improve model performance and efficiency. The optimization module 208 is responsible for adjusting the model's internal parameters continuously, using feedback from relevant loss functions tailored to the application (e.g., text, image, audio, or video generation). Techniques such as gradient clipping, learning rate scheduling, and mixed-precision training are applied by the optimization module 208 to stabilize and fine-tune the training process. Gradient clipping may be used to stabilize the training process, especially in transformer-based models, by capping the magnitude of gradients to prevent them from becoming excessively large. Learning rate scheduling may involve gradually increasing the learning rate during initial training phases (warm-up) and then decaying it as training progresses to fine-tune the model's parameters more effectively. Mixed-precision training, which leverages lower-precision (e.g., float16) arithmetic while retaining higher precision (e.g., float32) for specific calculations, may be used to accelerate training and reduce memory consumption, enabling the model to scale efficiently even when trained on large datasets.

In some embodiments, the model training engine 206 may implement early stopping mechanisms to prevent overfitting. Early stopping monitors the generative AI model's performance on the validation dataset, halting the training process if the performance does not improve after a specified number of iterations. This ensures that the generative AI model does not continue training on noise or irrelevant patterns, which could degrade its performance on unseen data. The model training engine 206 may also support distributed training across multiple computing nodes, allowing the system to scale its computational resources as needed. Distributed training may involve splitting the generative AI model and data across multiple machines or GPUs, where each node processes a portion of the data and updates the model in parallel. This is particularly useful for large datasets or models that require significant computational power, such as deep generative models. The model training engine 206 may synchronize the updates across the nodes using techniques like synchronous or asynchronous gradient descent.

Once the generative AI model is trained, the model training engine 206 may save the final trained generative AI model in a persistent storage location for future use. In specific embodiments, metadata such as the number of epochs, the final loss values, and values of learned parameters may be logged for model versioning and/or retraining at a later stage. In some embodiments, the model training engine 206 may also implement transfer learning, where a pre-trained model is fine-tuned on a smaller, domain-specific dataset. This may reduce the amount of time and data required to train a new model, especially in cases where the available data is limited or highly specialized. The model training engine 206 may adjust the parameters of the pre-trained model to better align with the new dataset, while preserving the learned features from the original training.

In embodiments involving LLMs, new output is generated by sampling from the model's probability distribution of tokens, conditioned on the context provided as input. Transformer-based architectures, such as GPT, use an auto-regressive approach where the model predicts the next token in a sequence one step at a time, using previously generated tokens as input for subsequent predictions. The process starts with a prompt or an initial sequence of words, and the model iteratively generates new tokens, forming coherent sentences or paragraphs based on the learned context and language patterns. For masked-language modeling (e.g., BERT), new output may be generated by filling in masked parts of the input sequence, allowing the model to complete sentences or generate variations of the provided text. The generated output can be controlled by adjusting parameters such as creativity, which influences the randomness of the token sampling, enabling the generation of diverse or deterministic responses.

In image generation models, such as those using ViTs or GANs, new output is generated by sampling from the learned distribution in the model's latent space. For GANs, the generator network creates an image by transforming random noise vectors into structured image outputs through a series of layers that learn visual features like shapes, textures, and colors. The generated image is then refined through adversarial feedback from the determinator network, which assesses the realism of the generated output. For transformer-based image models, the process may involve reconstructing images by assembling patches based on the learned dependencies between them. Input conditions, such as prompts describing desired features or specific noise vectors, guide the generation process, allowing for the creation of customized images or variations of existing visual styles. These models may also generate images based on style transfer techniques or predefined templates, synthesizing images that align with the characteristics present in the training data.

Video generation models utilize spatiotemporal dependencies to synthesize new video sequences based on the patterns learned during training. In transformer-based architectures, the model may generate video frames sequentially, predicting the next frame based on the input frames and the temporal context established by prior frames. GAN-based models, specifically designed for video synthesis, may sample noise vectors or use a sequence of frames as input, transforming these into continuous and temporally coherent video outputs through the generator network. The determinator evaluates the temporal consistency and realism of the output, ensuring the generated video mimics the motion dynamics and object interactions present in real-world video data. Such models may also use attention mechanisms to focus on critical elements within each frame and their evolution across time, facilitating realistic scene transitions and motion patterns. The generation process may include user-defined input such as initial frames, motion descriptions, or specific video attributes, providing control over the output.

Audio generation models, including Audio Transformers or autoregressive architectures like WaveNet, generate new audio sequences by predicting audio samples based on learned dependencies in sequential sound data. For autoregressive models, the generation process involves producing each audio sample one at a time, conditioned on previously generated samples, allowing the model to build complex audio patterns such as speech, music, or ambient sounds. The model starts with an initial segment or a random seed and uses its learned parameters to predict and synthesize subsequent samples, constructing a continuous audio waveform. Audio Transformers, on the other hand, may use attention mechanisms to identify important temporal segments within the input audio and synthesize new output based on these learned patterns. The user can control the type of audio generated by providing parameters such as pitch, tempo, or initial sound clips, enabling the model to generate outputs tailored to specific use cases like speech synthesis, music composition, or environmental sound generation.

In some embodiments, generative AI models may also integrate multiple modalities, enabling cross-modal generation where output in one modality influences or conditions the generation in another. For example, a video generation model may use text descriptions as input, synthesizing video content that aligns with the specified narrative or visual scene described. Similarly, image generation models may generate visual representations based on audio inputs, such as generating animations synchronized to musical rhythms or speech patterns. These cross-modal systems typically involve conditional GANs or multi-modal transformers, where the model processes input from one domain (e.g., text or audio) and learns to generate output in another domain (e.g., video or image) by aligning the patterns and dependencies between the different modalities. These models may allow users to generate complex, multimodal content based on combinations of inputs, such as using textual prompts to control the visual and auditory elements of a video.

It will be understood that the embodiment of the generative AI subsystem 200 illustrated in FIG. 2 is exemplary and that other embodiments may vary. The generative AI subsystem 200, as well as its constituent elements, may vary, and modifications or alternative configurations may be implemented without departing from the broader scope of the invention. For instance, different machine learning algorithms, data sources, optimization techniques, or training methodologies may be employed depending on system requirements, application domain, and available computational resources. Furthermore, features and functionalities described in one embodiment may be combined with those of another embodiment as needed, and vice versa.

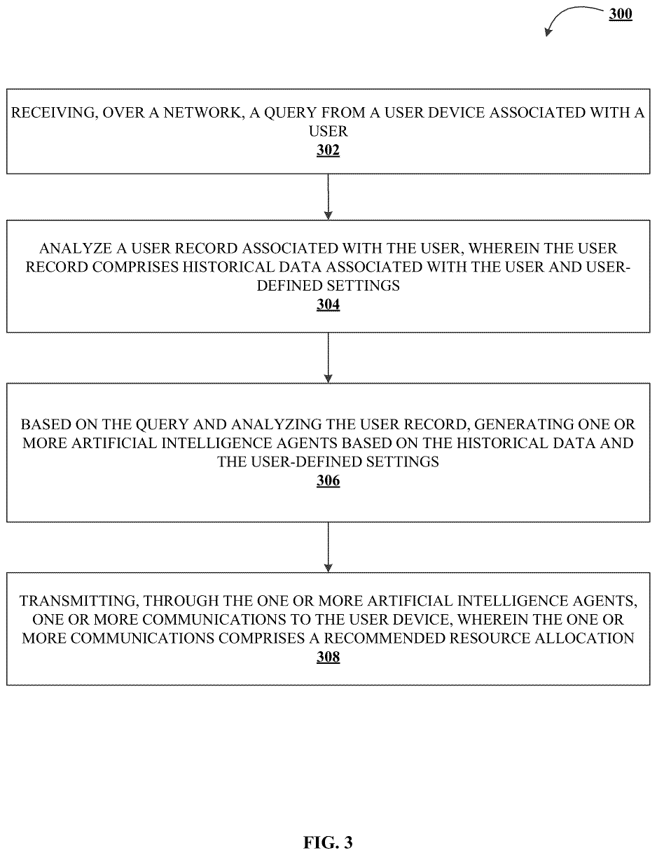

FIG. 3 illustrates a method 300 for directing resource allocations using artificial intelligence based agents. As shown in block 302, the method includes receiving, over a network, a query from a user device associated with a user. The query may be, for instance, a question or prompt from the user to provide a recommendation regarding a resource allocation (e.g., how the user should allocate resources in a user resource account to reach or achieve a goal of the user). The query may be submitted, in some embodiments, through a user interface presented on a display of the user device, where the user interface may comprise various graphical interface elements for receiving the user query. For example, the interface elements may include a text entry field or box through which the user may submit the query. In other embodiments, the user may submit a query using a voice command, which may be parsed and analyzed using AI-based voice recognition capabilities.

Next, as shown in block 304, the method includes analyze a user record associated with the user, wherein the user record comprises historical data associated with the user and user-defined settings. The user record may contain various types of zero-party and/or first-party data regarding the user. For instance, the user record may comprise user-provided information (e.g., zero-party data) such as user preferences, settings, configurations, and/or the like that may have been communicated to the system by the user (e.g., through an application, e-mails, direct messages, and/or the like). The user record may further comprise information gathered regarding the user based on the user's previous interactions with the system (e.g., historical data such as past transactions, previously submitted queries, and/or the like). By analyzing the combination of zero-party and first-party data associated with the user, the system may provide tailored recommendations that are in line with the user's preferences and goals even when the user has not specifically expressed such preferences and goals to the system.

Next, as shown in block 306, the method includes based on the query and analyzing the user record, generating one or more artificial intelligence agents based on the historical data and the user-defined settings. Each of the one or more AI agents may comprise one or more unique characteristics, such as a name, appearance, voice, communication style, role, and/or the like. The unique characteristics may be designated by the system based on the zero-party and first-party data within the user record. For example, the characteristics of each AI agent may be selected based on the preferences and settings provided by the user (e.g., zero-party data) as well as preferences and settings inferred by the system using one or more AI/ML models (e.g., first-party data). In this regard, the system may make one or more inferences on the user's preferences based on detecting a positive or negative reaction or input from the user based on the system providing certain outputs to the user (e.g., communications, recommendations, insights, and/or the like).

In some embodiments, each of the one or more AI agents may be assigned a unique role in accordance with the information within the user record. For instance, a first AI agent may be a tracking agent that may track the progress of the user toward a specific goal; a second AI agent may be an analyst agent that may be configured to provide analyses and/or insights with respect to a particular resource allocation; a third AI agent may be a notification agent that may be configured to transmit notifications or recommendations to a user based on the user's behavior.

Next, as shown in block 308, the method includes transmitting, through the one or more artificial intelligence agents, one or more communications to the user device, wherein the one or more communications comprises a recommended resource allocation. The recommended resource allocation may be transmitted by one or more of the one or more AI agents. In this regard, the recommended resource allocation may comprise one or more recommendations on how the user should allocate a certain resource in alignment with the user's goals. For instance, if the user wishes to receive a 10%+return, the communication may include one or more recommendations to allocate the resources to a particular investment vehicle. In this way, the system may provide an intelligent, customized way to interface and communicate with the user regarding resource allocations.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for directing resource allocations using artificial intelligence based agents, the system comprising:
a processing device;
a non-transitory storage device containing instructions when executed by the processing device, cause the processing device to perform the steps of:
receiving, over a network, a query from a user device associated with a user;
analyze a user record associated with the user, wherein the user record comprises historical data associated with the user and user-defined settings;
based on the query and analyzing the user record, generating one or more artificial intelligence agents based on the historical data and the user-defined settings; and
transmitting, through the one or more artificial intelligence agents, one or more communications to the user device, wherein the one or more communications comprises a recommended resource allocation.

2. The system of claim 1, wherein each of the one or more artificial intelligence agents comprise one or more unique characteristics, the one or more unique characteristics comprise at least one of a name, appearance, voice, and communication style.

3. The system of claim 1, wherein each of the one or more artificial intelligence agents is associated with a unique role based on the user record.

4. The system of claim 1, wherein analyzing the user record comprises identifying one or more targets associated with the user, wherein the recommended resource allocation is based on the one or more targets associated with the user.

5. The system of claim 1, wherein the user record comprises zero-party data and first-party data associated with the user.

6. The system of claim 5, wherein the first-party data comprises inferred information based on past user interactions.

7. A computer program product for directing resource allocations using artificial intelligence based agents, the computer program product comprising a non-transitory computer-readable medium comprising code causing an apparatus to perform the steps of:
receiving, over a network, a query from a user device associated with a user;
analyze a user record associated with the user, wherein the user record comprises historical data associated with the user and user-defined settings;
based on the query and analyzing the user record, generating one or more artificial intelligence agents based on the historical data and the user-defined settings; and
transmitting, through the one or more artificial intelligence agents, one or more communications to the user device, wherein the one or more communications comprises a recommended resource allocation.

8. The computer program product of claim 7, wherein each of the one or more artificial intelligence agents comprise one or more unique characteristics, the one or more unique characteristics comprise at least one of a name, appearance, voice, and communication style.

9. The computer program product of claim 7, wherein each of the one or more artificial intelligence agents is associated with a unique role based on the user record.

10. The computer program product of claim 7, wherein analyzing the user record comprises identifying one or more targets associated with the user, wherein the recommended resource allocation is based on the one or more targets associated with the user.

11. The computer program product of claim 7, wherein the user record comprises zero-party data and first-party data associated with the user.

12. The computer program product of claim 11, wherein the first-party data comprises inferred information based on past user interactions.

13. A computer-implemented method for directing resource allocations using artificial intelligence based agents, the computer-implemented method comprising:
receiving, over a network, a query from a user device associated with a user;
analyze a user record associated with the user, wherein the user record comprises historical data associated with the user and user-defined settings;
based on the query and analyzing the user record, generating one or more artificial intelligence agents based on the historical data and the user-defined settings; and
transmitting, through the one or more artificial intelligence agents, one or more communications to the user device, wherein the one or more communications comprises a recommended resource allocation.

14. The computer-implemented method of claim 13, wherein each of the one or more artificial intelligence agents comprise one or more unique characteristics, the one or more unique characteristics comprise at least one of a name, appearance, voice, and communication style.

15. The computer-implemented method of claim 13, wherein each of the one or more artificial intelligence agents is associated with a unique role based on the user record.

16. The computer-implemented method of claim 13, wherein analyzing the user record comprises identifying one or more targets associated with the user, wherein the recommended resource allocation is based on the one or more targets associated with the user.

17. The computer-implemented method of claim 13, wherein the user record comprises zero-party data and first-party data associated with the user.

18. The computer-implemented method of claim 17, wherein the first-party data comprises inferred information based on past user interactions.
